(19) United States
(12) Patent Application Publication
(10) Pub. No.: US 2017/0191859 A1
(43) Pub. Date: Jul. 6, 2017

(54) Method For Acquiring Health Information From The Hydraulic Circuit Of A Toilet

(71) Applicants: David R. Hall, Provo, UT (US); Dan Allen, Springville, UT (US); Terrece Pearman, Draper, UT (US)

(72) Inventors: David R. Hall, Provo, UT (US); Dan Allen, Springville, UT (US); Terrece Pearman, Draper, UT (US)

(21) Appl. No.: 15/338,760

(22) Filed: Oct. 31, 2016

Related U.S. Application Data
(60) Provisional application No. 62/275,379, filed on Jan. 6, 2016.

(51) Int. Cl. G01F 22/00; E03D 11/13; G01F 23/24

(52) U.S. Cl. CPC G01F 22/00; G01F 23/24; E03D 11/13; E03D 2201/00

(57) ABSTRACT

The present invention is directed to a toilet that includes one or more water volume and flow rate sensors on the surface of a P-trap. Changes in volume within the toilet's hydraulic circuit indicate volume of excrement added. Changes in rate of flow through the P-trap indicate rate of excretion. The sensors may be electrical capacitors. The capacitance readings may provide data relevant to a user's health status or assist in diagnosis of disease.

### CROSS-REFERENCE TO RELATED APPLICATIONS

This application claims priority to U.S. provisional patent application Ser. No. 62/275,379 filed on Feb. 12, 2016 the entire contents of which is hereby incorporated by reference.

### BACKGROUND

Field of the Invention

This invention relates to toilets, and, in particular, toilets capable of detecting the volume of material added to the toilet bowl.

Background of the Invention

In a toilet configured to refill the toilet bowl up to a point that is below a trap way overflow level, a level sensor may record a level change corresponding to a volume of waste deposited in the toilet bowl. Measuring the urination and defecation volumes may be useful for clinical monitoring as well as for at-home health trending and diet monitoring.

Various flow meters have been proposed for measuring the flow of water within the hydrostatic circuit of a toilet. Flow meters in a toilet may be used to measure urine flow rates, track overeating, measure diarrhea volumes, as well as applications for conservation (optimal flush volumes) and clog detection. Typical flow meters assume a full pipe, which is not the case in a toilet, and measure Doppler effects with ultrasound or heat flow with a heater and a temperature sensor. These methods are quite challenging with a porcelain toilet. Others have proposed to place a valve below the trap way which will drain standing water and then measure the volume in time with a water level meter and differentiate to obtain flow rates. This method includes issues with cost, hygiene, and reliability due to the presence of a water drain with a narrow diameter valve used in a toilet used to dispose of excrement. A better consumer toilet with a flow meter is needed.

### SUMMARY

We disclose a novel device for measuring a volume of excrement added to a toilet. Measurements of excrement, including urine and feces, may be used to monitor a user's health status. The device includes a toilet hydraulic circuit which includes a P-trap. One or more noncontact electrical impedance sensors, each of which may be capacitance sensors, may be attached to the outer surface of the P-trap. Depending at least on the position and orientation of the one or more sensors, changes in water volume and/or flow rate within the hydraulic circuit may be detected.

The toilet may include other sensors that may provide readings that, along with the capacitance sensors, may provide additional data to assess a user's health status. These may include a gas analyzer for measuring volatile organic compounds (VOCs) emitted by bodily waste or flatulence, a blood pressure monitor, and a colorimeter for measuring the color of liquid and solid waste deposited into the toilet.

Some embodiments include a processor which performs tasks including, but not limited to, recording data from the capacitance sensors, combining this data with that collected from other sensors, and providing reports that may be relevant to a user's health status.

### BRIEF DESCRIPTION OF THE DRAWINGS

FIG. 1 is a schematic drawing of a toilet illustrating a hydraulic circuit at equilibrium.

FIG. 2 is a schematic drawing of a toilet illustrating a hydraulic circuit with the water level above equilibrium.

FIG. 3 is a schematic drawing of the toilet of FIG. 2 with a capacitive sensor positioned perpendicular to the static level of water.

FIG. 4 is a schematic drawing of the toilet of FIG. 3 with a capacitive sensor positioned parallel to the static level of water.

FIG. 5A is a schematic drawing of the toilet of FIG. 2 with a capacitive sensor in a collar configuration around the P-trap.

FIG. 5B is a cross-sectional view of the top of the P-trap shown in FIG. 5A.

FIG. 6A illustrates a V-shaped capacitive sensor.

FIG. 6B is a schematic drawing of the toilet of FIG. 2 with a capacitive sensor in a V-shaped configuration around the P-trap.

FIG. 6C is a cross-sectional view of the top of the P-trap shown in FIG. 6B.

FIG. 7A illustrates a bow tie-shaped capacitive sensor.

FIG. 7B is a is a schematic drawing of the toilet of FIG. 2 with a capacitive sensor in a bow tie configuration around the P-trap.

FIG. 7C is a cross-sectional view of the top of the P-trap shown in FIG. 7B.

FIG. 8 is a schematic drawing of a capacitive sensor positioned at the overflow point on the surface of a P-trap.

FIG. 9 is the P-trap and capacitive sensor of FIG. 8 with a second noncontact electrical impedance sensor further along the P-trap.

FIG. 10 is a schematic illustration of electrical strips according to an embodiment of the invention.

FIG. 11 is a graph illustrating flow-type discrimination as measured by an embodiment of the invention.

FIG. 12 is a graph illustrating flow measured during a normal flush and a clogged toilet as measured by an embodiment of the invention.

FIG. 13 illustrates a toilet including an air vent leading to an air sensor according to an embodiment of the invention.

### DETAILED DESCRIPTION

### Definitions

Toilet, as used herein, means a device that may be used to collect one or more biological waste products of a user.

User, as used herein, means a human or animal that deposits bodily waste into an embodiment of the toilet disclosed herein.

P-trap, as used herein, means a section of pipe connecting the toilet bowl to a sewer pipe through which waste passes into the sewer system. The section of pipe is typically curved with the section nearest the toilet bowl holding water when the toilet bowl is full. The section nearest the sewer pipe does not hold water. The P-trap may also be called a trap way or S-trap.

Water seal, as used herein, means a vertical section of a trap way which holds a column of water, the water acting as a barrier for sewer gases which would otherwise travel from a sewer pipe connected to the trap way into the toilet bowl.

Overflow point, as used herein, means the upper point of the water seal. When water in the trap way increases such that the height of the column of water exceeds the overflow point, a siphon is initiated and the excess water begins to flow through the trap way toward the sewer pipe.

Spillway, as used herein, means the section of the trap way through which water and material added to the toilet bowl flow when the volume of water in the P-trap increases to the point that the height of the water seal is above the overflow point. At this point, a siphon action is initiated and the water and other material in the water flow through the spillway towards the sewer.

Water, as used herein, means water without significant additives or water with waste added to it. For example, water, as used herein, may include urine, feces (either liquid or solid), vomit or other material added to the toilet bowl by a user.

Disclosed herein is a toilet capable of measuring small changes in volume within the toilet's hydrostatic circuit. Specifically, the disclosed toilet comprises at least one noncontact electrical impedance sensor which may be a capacitive sensor which detects small changes in volume within the toilet bowl. The disclosed toilet also measures flow rate through a P-trap which indicates the rate of volume being added to the toilet bowl over time. This is also accomplished using a noncontact electrical impedance sensor which may be a capacitive sensor. Because the toilet includes a hydrostatic circuit that reacts throughout when material is added to the toilet bowl, the volume of human excrement, including urine, feces, vomit, or other bodily waste that is deposited into the toilet bowl is detected as well as the rate at which it is deposited by taking measurements along the P-trap. This information may be used to provide information about a user's health status.

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

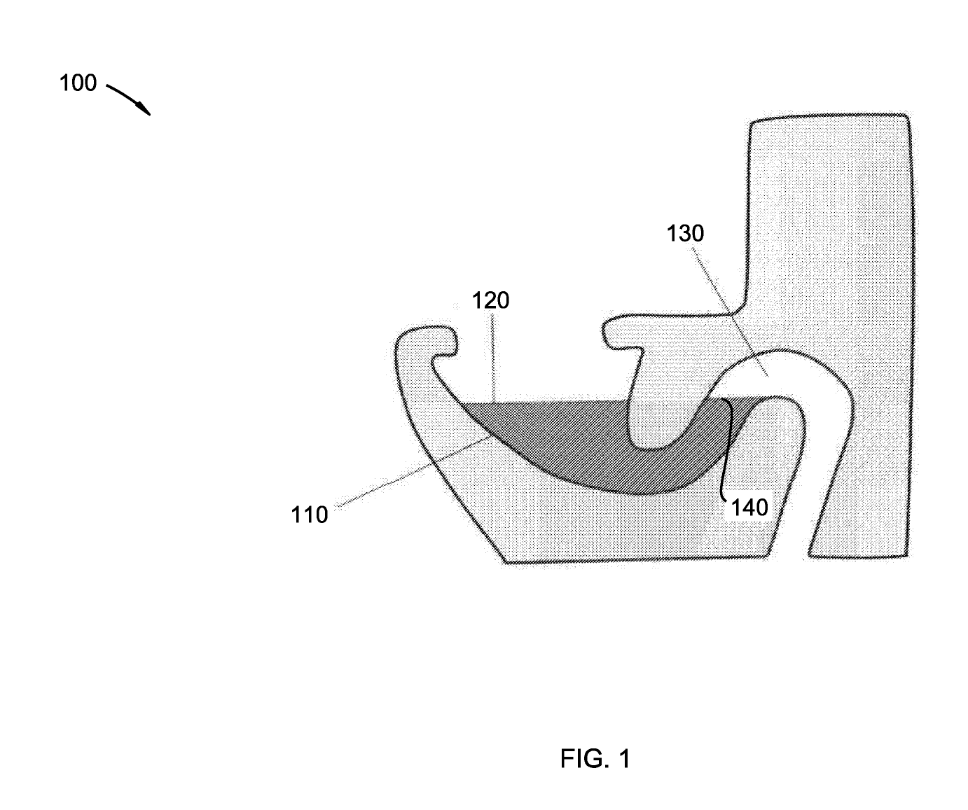

Referring to FIG. 1, toilet 100 is illustrated as a cross-sectional schematic drawing of a toilet with the toilet's hydraulic circuit at equilibrium. Toilet 100 includes toilet bowl 110 with bowl equilibrium water level 120. Because the water is at bowl equilibrium water level 120, the water in P-trap 130 is at P-trap equilibrium level 140. Consequently, the water does not flow past the overflow point through the P-trap causing a siphon action as occurs during flushing.

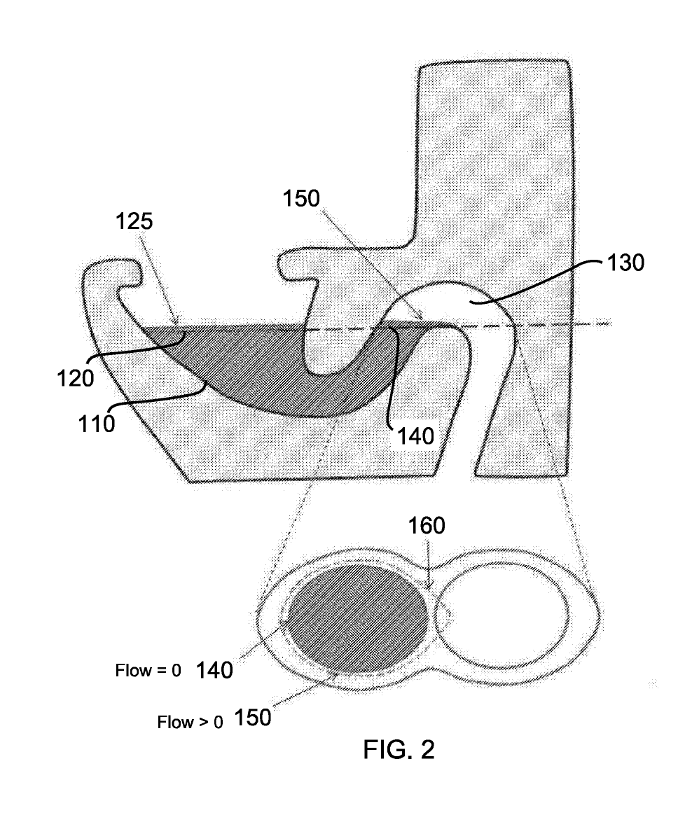

FIG. 2 illustrates the toilet of FIG. 1 except that additional water has been added to the hydraulic circuit. The water in toilet bowl 110 has reached elevated bowl level 125. This causes the water level in the P-trap to rise to elevated P-trap level 150. The water in the P-trap begins to flow over the spillway in P-trap 130. Water front 160 shows the movement of the water over the spillway towards a sewer pipe. Because the toilet comprises a hydraulic circuit, small increases in volume added to the toilet bowl as occur when a user deposits bodily waste into the toilet bowl cause an increase in water levels both in the toilet bowl and the P-trap. The increase in volume of the hydraulic circuit may be extrapolated to the volume of waste a user has deposited in the toilet. Knowledge of the volume of a user's waste as well as other details about the waste that may be identified according to various embodiments described herein may be used to provide an assessment of a user's health status.

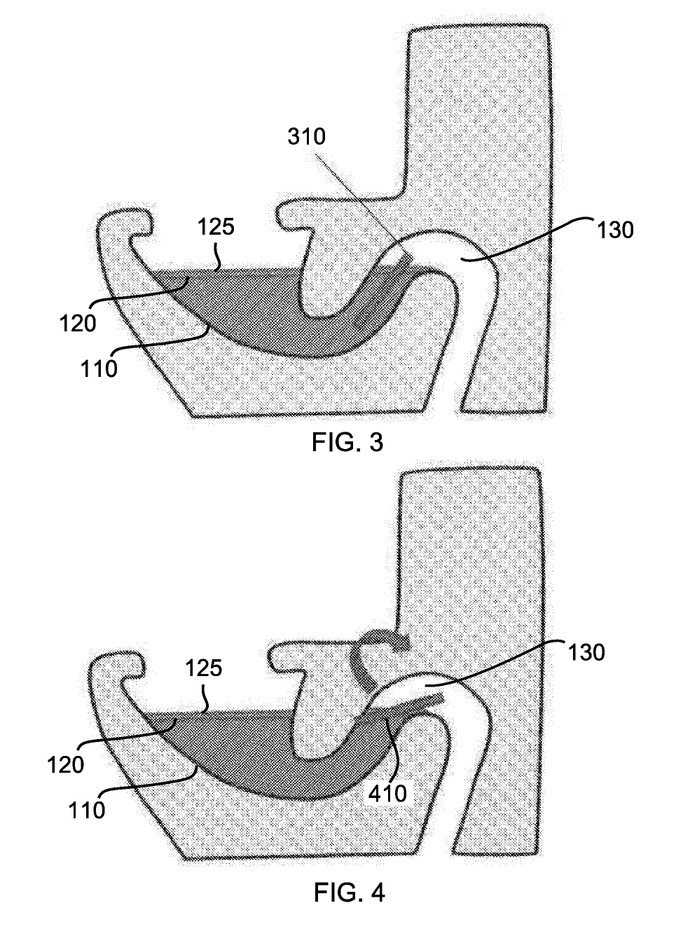

FIG. 3 shows the toilet of FIG. 2 with capacitive sensor 310. The toilet may be constructed of a non-electrically conductive, non-ceramic material. In this embodiment, capacitive sensor 310 is positioned on the outer surface of the P-trap at and below P-trap equilibrium level 140. Capacitive sensor 310 is also relatively perpendicular to the flow of water through the spillway. In this position, capacitive sensor 310 measures water level by measuring height of the water seal above P-trap equilibrium point 140.

In some embodiments, the capacitive sensor may be connected to a processor which may include a capacitance analyzer. The capacitance analyzer may perform calculations on the capacitive sensor readings, store the readings and calculated data, and transfer the calculated data to a network. In some embodiments, the processor has a digital display. The capacitance analyzer may calculate volume added to the hydraulic circuit in a piecewise fashion. In embodiments, including that shown in FIG. 3 in which the capacitive sensor is positioned below the crest of the spillway, the capacitive sensor reading may be scaled by a function that converts the reading to a volume.

FIG. 4 illustrates the toilet of FIG. 2 with capacitive sensor 410. In this embodiment, the position of capacitive sensor 410 is different than that of capacitive sensor 310 shown in FIG. 3. Specifically, capacitive sensor 410 is rotated more toward the horizontal plane which is nearer to a position that is approximately parallel to the flow of water through the spillway. Sensitivity of the capacitive sensor may increase as its position is rotated toward the horizontal as it achieves more bend around the pipe. This increased bend is illustrated by the curved arrow in FIG. 4. While FIGS. 3 and 4 illustrate embodiments in which the capacitive sensors are approximately perpendicular to and parallel to the flow of water respectively, other embodiments may comprise of capacitive sensors positioned at any angle in between these two positions.

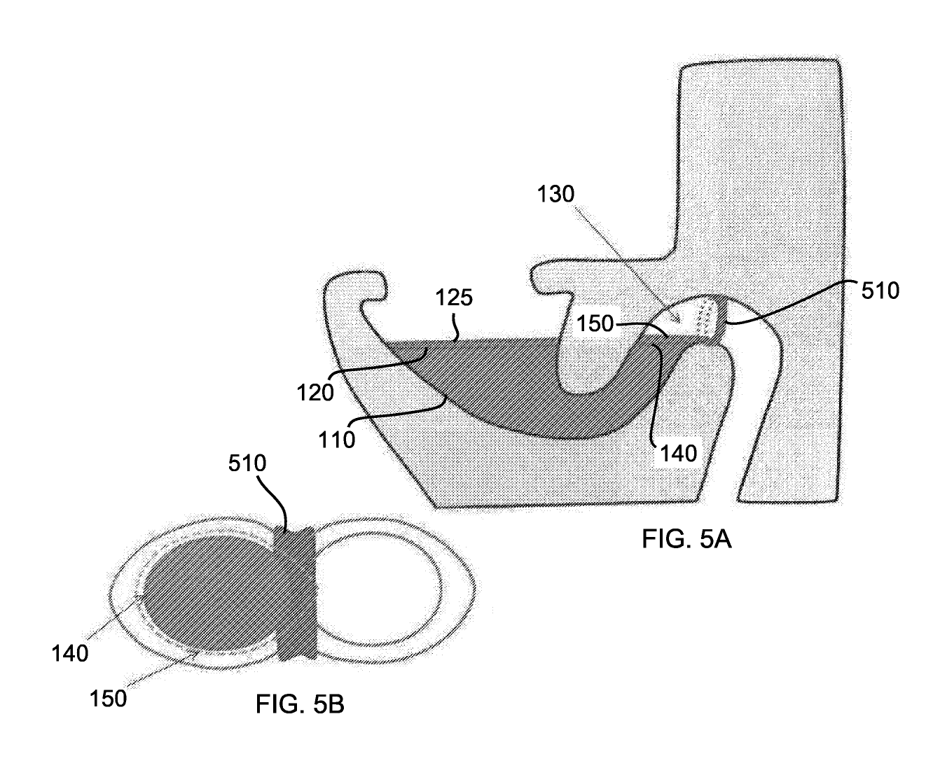

FIG. 5A illustrates the toilet of FIG. 2 with capacitive sensor 510. Capacitive sensor 510 is positioned around P-trap 130 in a “collar” configuration. Also, capacitive sensor 510 is positioned along P-trap 130 further from the water seal and in the region of the spillway. In this position along P-trap 130, capacitive sensor 510 (and other embodiments thereof) measure water flow rate rather than volume of water in P-trap 130. In other words, in this position, capacitive sensor 510 detects width of flow rather than height in a low flow regime. This may be compared to using the shoreline to detect the changing sea level.

FIG. 5B illustrates a cross-section of P-trap 130 as shown in FIG. 5A with capacitive sensor 510 wrapped around the region of P-trap 130 where water flows over the spillway. Note the overlap between capacitive sensor 510 and the lip of the water at elevated P-trap level 150.

In the embodiment illustrated in FIGS. 5A and 5B, flow rate, rather than volume, may be calculated when the capacitive sensor readings are processed by a capacitance analyzer. The capacitance analyzer may comprise of software loaded onto a processor which may be connected to capacitance sensor 510. Like volume, flow rate may be calculated in a piecewise fashion. While the water level is below the spillway, the capacitive sensor reading may be converted to height scaled by a function that converts capacitive sensor readings (e.g. capacitance corresponding to a water level) to a volume (depending on the shape of the toilet bowl). The volume times series may then be differentiated to provide the flow rate. When the water level reaches the spillway, the capacitive sensor reading may be scaled by a function that directly converts height to flow rate.

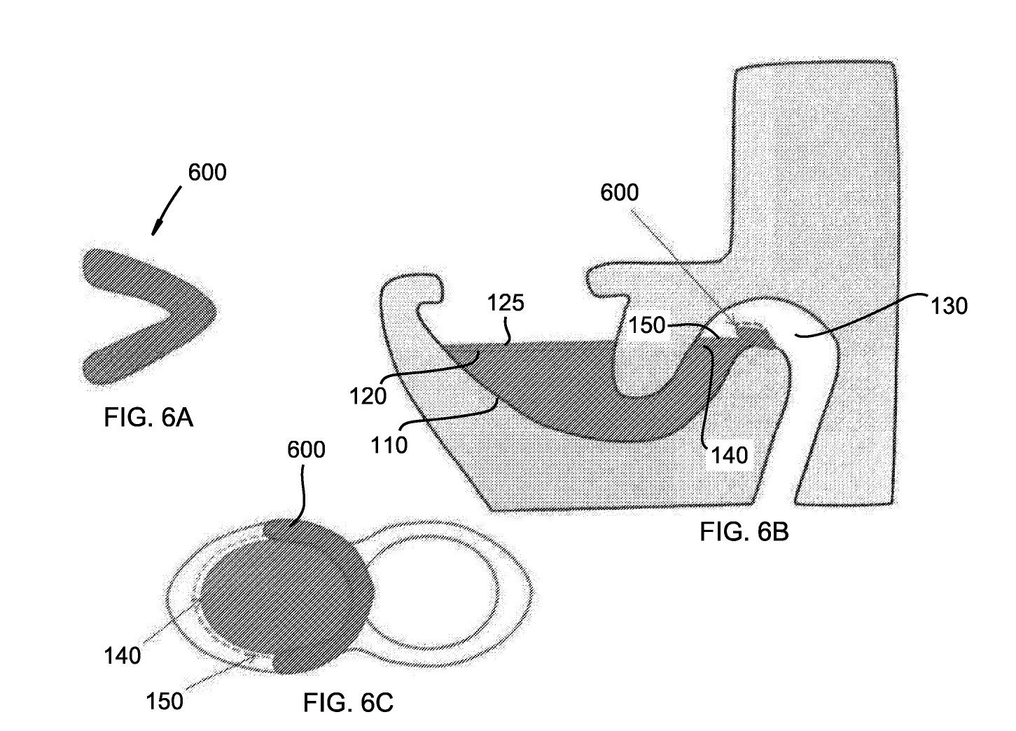

FIG. 6A illustrates capacitive sensor 600 which is in a V-shaped configuration. Capacitive sensor 600 may be wrapped around the underside of P-trap 130 as illustrated in FIG. 6B. In this embodiment, the pipe of P-trap 130 sits within the apex of the “V”.

FIG. 6C is a cross-section of P-trap 130 with capacitive sensor 600 as shown in FIG. 6B. As in FIGS. 5B and 5C, there is overlap between capacitive sensor 600 and the lip of the water at elevated P-trap level 150. Also like the embodiment shown in FIGS. 5B and 5C, when the capacitance sensor is positioned as shown in FIGS. 6B and 6C, flow rate, rather than volume, may be calculated.

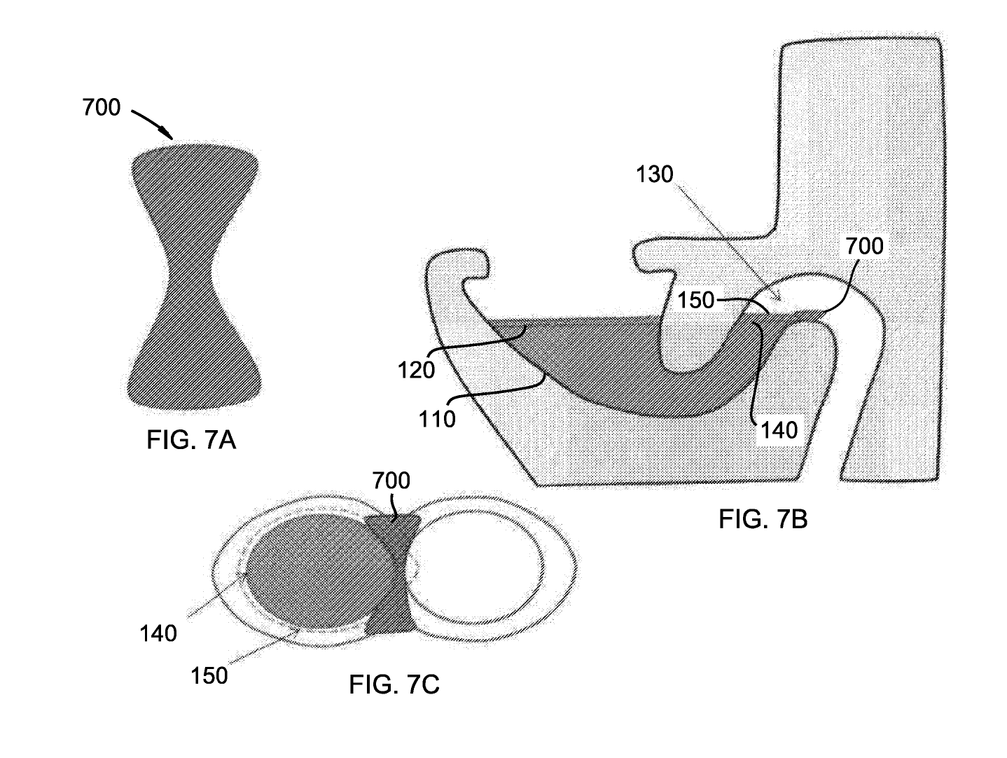

FIG. 7A illustrates capacitance sensor 700 which is yet another embodiment of the invention disclosed herein and which is in a “bow tie-shaped” configuration. FIG. 7B illustrates an embodiment in which capacitive sensor 700 is wrapped around the underside of P-trap 130. In this embodiment, the pipe of P-trap 130 sits within the middle, more narrow section of the “bow tie” where the knot of the “bow tie” would be.

FIG. 7C illustrates a cross-section of P-trap 130 with capacitive sensor 700 as shown in FIG. 7B. As in FIGS. 5B and 5C, there is overlap between capacitive sensor 700 and the lip of the water at elevated P-trap level 150. Also like the embodiment shown in FIGS. 5B and 5C, when the capacitance sensor is positioned as shown in FIGS. 7B and 7C, flow rate, rather than volume, may be calculated.

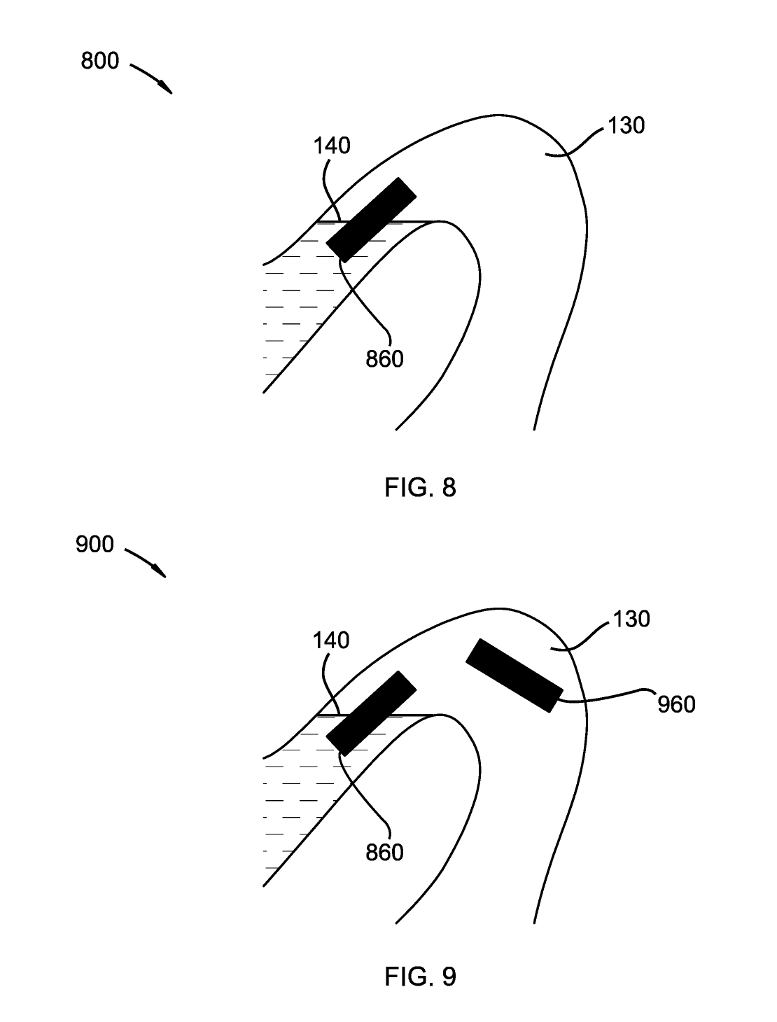

FIG. 8 is schematic illustration of P-trap 130 with capacitance sensor 860 positioned on the surface of the P-trap pipe across the water level and approximately perpendicular to the direction of flow. In this scenario, the water is at P-trap equilibrium level 140. Capacitance sensor 860 may perform similar to as capacitance sensor 310 of FIG. 3. Consequently, capacitance sensor 860 may collect readings that indicate changes in water volume in P-trap 130.

FIG. 9 illustrates an embodiment which is similar to the embodiment of FIG. 8 with the addition of capacitance sensor 910. Note that capacitance sensor 910 is positioned further along P-trap 130 into the spillway. Consequently, capacitance sensor 910 may collect readings which may indicate changes in water flow rate through P-trap 130.

The embodiment shown in FIG. 9 senses water level above and below the lip of the spillway within P-trap 130. When the water level is below the lip, sensor 860 provides readings which may indicate water height. A capacitance analyzer connected to the capacitance sensors 860 and 960 may register the reading from capacitance sensor 860 as a first capacitance. When the water level exceeds the lip and flows into the spillway, capacitive sensor 960 provides readings that correspond to water flow rate. The reading collected by capacitive sensor 960 may be registered by the capacitance analyzer as a second capacitance. The second capacitance may be lower than the first capacitance. The first and second capacitances may be integrated and calculated to determine a volume of water flow.

The dual capacitive sensor as shown in FIG. 9 and other embodiments thereof has the advantage of being able to measure small flows accurately using the water level sensor below the lip of the spillway and large flows accurately using the capacitance sensor located above the lip of the spillway.

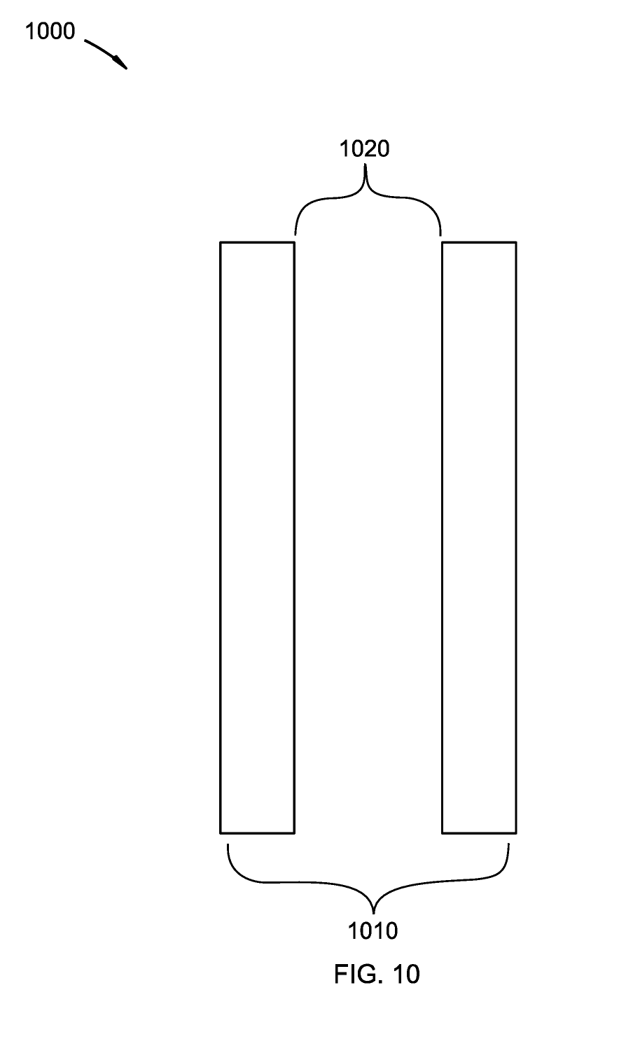

FIG. 10 illustrates capacitive sensor 1000. The capacitor includes capacitor plates 1010 which are separated by gap 1020. Capacitor plates 1010 function as capacitively coupled electrodes and may be two substantially parallel metal strips. Capacitor plates 1010 may be powered by an alternating current (AC) power source. While FIG. 10 illustrates linear metal strips, other embodiments of the capacitance sensors may be annular or semi-annular. As discussed above, the metal strips may be oriented vertically, horizontally, diagonally, or any angle in between relative to the flow of water through the hydraulic circuit.

In some embodiments, the capacitor is covered by an electrical shield. Some embodiments further include an insulating material. The insulating material may be placed between the electrical shield and the electrodes in a sandwich configuration. A clamp may secure the electrical shield against the insulating material. In some embodiments, the claim is circular and wraps at least partially around the circumference of the P-trap similar to a pipe clamp.

The insulating material may be magnetic. Furthermore, the insulating material may be constructed from a ferrite material, a ferrite composite material, a mumetal, or other magnetic insulating material known by those of skill in the art to be suitable for shielding the capacitive sensor against static, cross-talk from other sensors, or other low-frequency magnetic fields. The magnetic insulator may serve to reduce the electro-magnetic losses and direct he electro-magnetic field of the capacitive sensor to produce a more accurate capacitance based reading of the water flow through the P-trap.

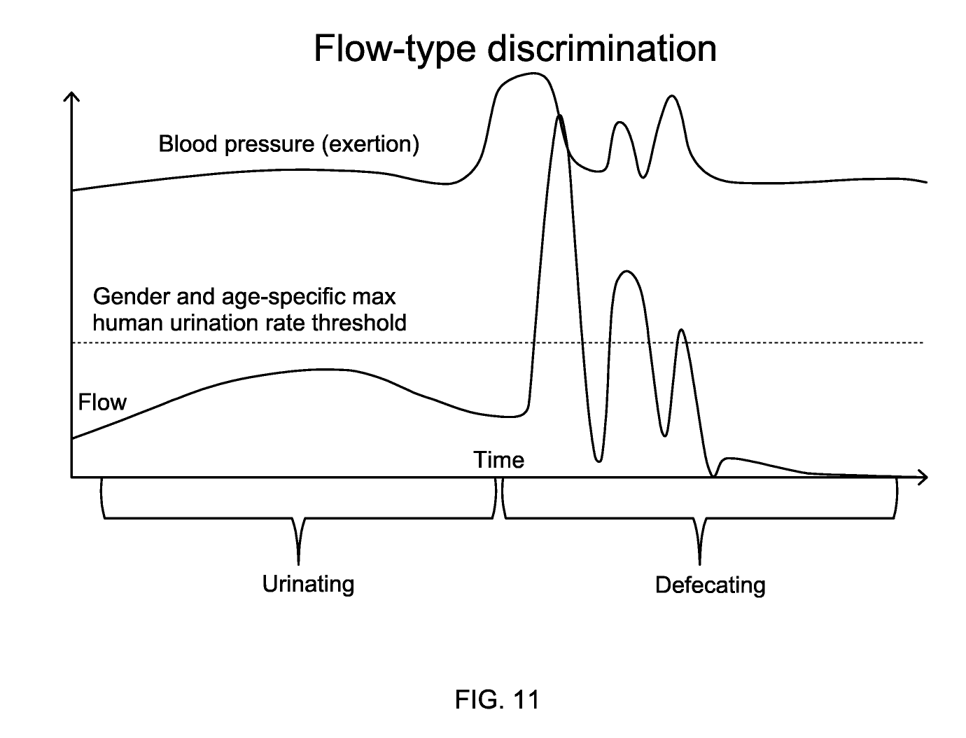

FIG. 11 shows a graph illustrating how the capacitance sensors disclosed herein may discriminate between different types of waste that a user may deposit into a toilet based on the water flow readings. The x-axis of the graph represents time and the y-axis represents change in water flow rate. In the beginning of the data collection, the flow gradually increases then gradually decreases. This is indicative of a user's urine flow rate. The second section of the graph shows discrete peaks illustrating short bursts of increased water flow rate. This pattern is indicative of a defecation event in which the user deposits discrete volumes of solid waste.

The graph of FIG. 11 also illustrates the user's blood pressure over time. In some embodiments, the toilet may include a blood pressure monitor. Blood pressure readings may be used to assess exertion that occurs as a user urinates or defecates. This information may be clinically significant. As shown in FIG. 11, urination causes a subtle increase in blood pressure which gradually trails off as urination ends. Defecation, however, requires bursts of exertion as shown by the discrete peaks in the blood pressure tracing that correlate with discrete increases in fecal matter deposited into the toilet as measured by changes in water flow rate.

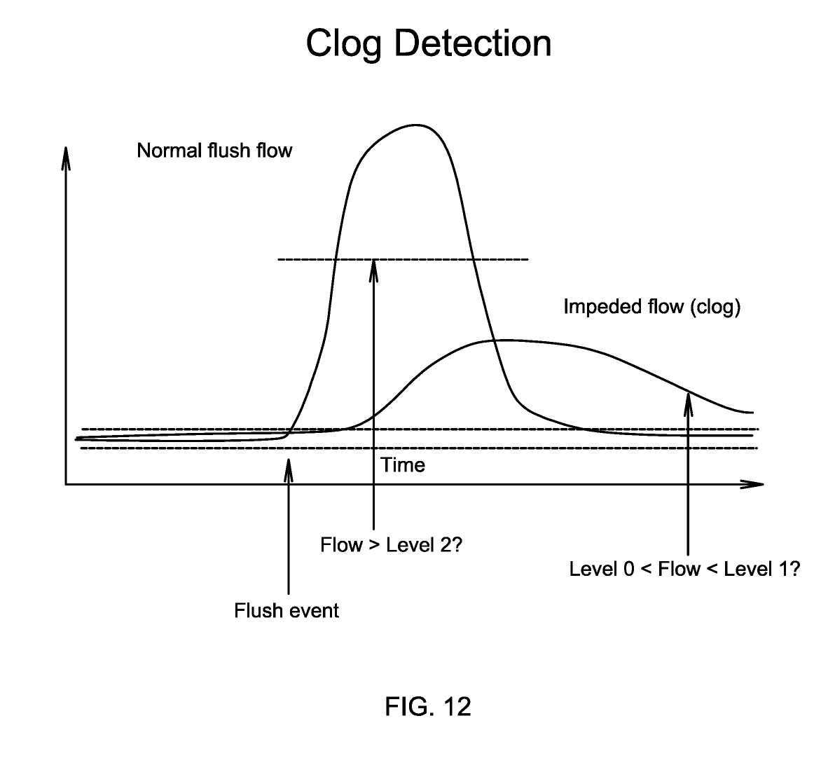

FIG. 12 is a graph showing how the capacitance sensors may be used to detect clogs in the toilet. After a flush which does not involve a clog, the flow rate abruptly increases then rapidly increases back to baseline. When the hydraulic circuit is clogged, the rate of water flow increases and decreases much more gradually and the peak flow is not as great as occurs without the clog.

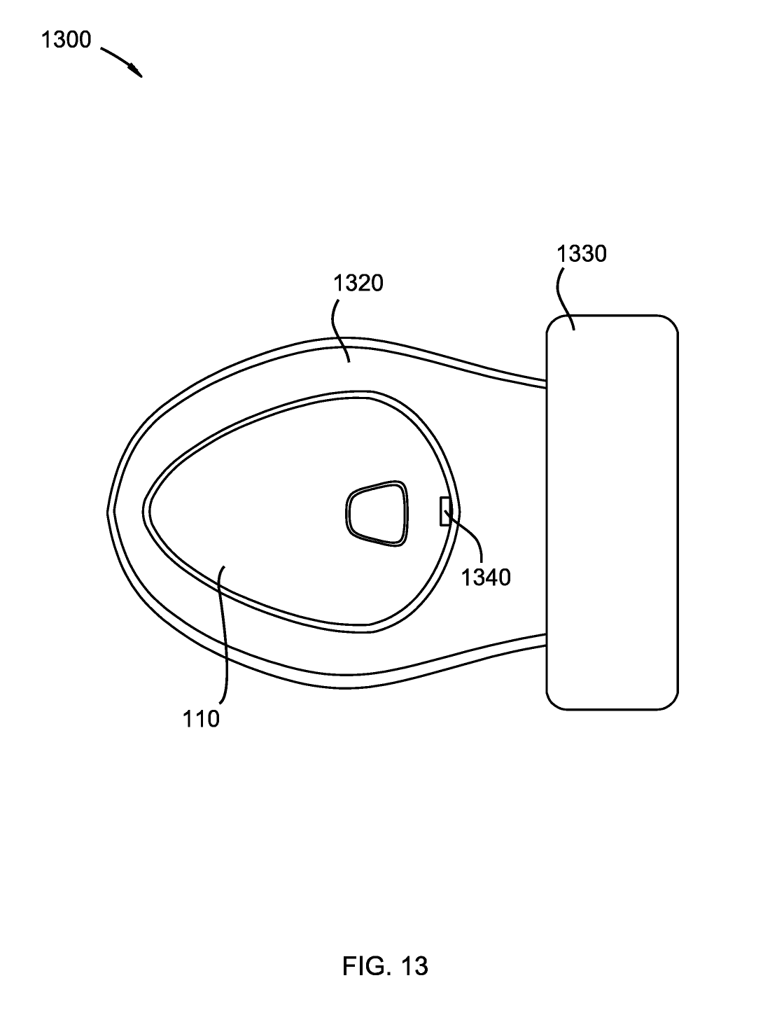

FIG. 13 illustrates toilet 1300 which includes toilet bowl 110, rim 1320, and tank 1330. Toilet 1300 further includes air vent 1340 which may be connected to a gas analyzer. The gas analyzer may detect volatile organic compounds (VOCs) that may be present when a user deposits waste into the toilet or when the user emits flatulence. In some instances, the gas analyzer may detect VOCs emitted from a user's urine. The toilets described herein with various embodiments of the one or more capacitance sensors may include an embodiment of the gas analyzer. Information about the waste deposited into the toilet along with the analysis of VOCs may provide further information that may be of clinical relevance. For example, when a user has had a bowel movement and deposited fecal matter into the toilet bowl, the gas analyzer may detect VOCs and the capacitance sensor may detect an increase in volume within the toilet bowl. Alternatively, when a user has experienced flatulence without an accompanying bowel movement, the gas analyzer may detect VOCs but the capacitance sensor may detect no increase in volume within the toilet bowl. The gas analyzer may be connected to the processor which may record, analyze, and transfer collected data.

The toilet disclosed herein may further include a colorimeter which may be connected to the processor. The colorimeter may measure changes in the color of liquid in the bowl for purposes of analyzing urine or liquid feces. For example, the colorimeter reading, along with determination of urine volume as measured by the capacitance sensors, may be used to calculate urine concentration. The colorimeter may also detect colors of solid materials deposited into the toilet bowl. The color of liquid and solid waste may be used to extrapolate information that is relevant to a user's health status.

While specific embodiments have been described above, it is to be understood that the disclosure provided is not limited to the precise configuration, steps, and components disclosed. Various modifications, changes, and variations apparent to those of skill in the art may be made in the arrangement, operation, and details of the methods and systems disclosed, with the aid of the present disclosure.

Without further elaboration, it is believed that one skilled in the art can use the preceding description to utilize the present disclosure to its fullest extent. The examples and embodiments disclosed herein are to be construed as merely illustrative and exemplary and not a limitation of the scope of the present disclosure in any way. It will be apparent to those having skill in the art that changes may be made to the details of the above-described embodiments without departing from the underlying principles of the disclosure herein.

We claim:

1. A method for metering a volume added to a toilet bowl, comprising the steps of:
providing a toilet hydraulic circuit, the hydraulic circuit comprising a water source, a toilet bowl, and a P-trap, wherein the toilet bowl is connected to the water source and to the P-trap;
wherein the P-trap comprises a curved pipe comprising an exterior surface and a water seal, the top of the water seal defining an overflow point, wherein at least a portion of the exterior surface comprises an electrical insulator;
providing a first noncontact electrical impedance sensor, the first noncontact electrical impedance sensor comprising at least one capacitively coupled electrode and an alternating current power source which provides alternating current electrical power to the at least one capacitively coupled electrode;
wherein the at least one capacitively coupled electrode wraps at least partially around the exterior surface of the curved pipe;
wherein the first noncontact electrical impedance sensor is disposed adjacent to the electrical insulator and positioned on the curved pipe at the overflow point or between toilet bowl and the overflow point.

2. The method of claim 1, further comprising the step of providing a processor, wherein the processor comprises a capacitance analyzer and is connected to the first noncontact electrical impedance sensor;
wherein a change in the height of water within the water seal is detected by the first noncontact electrical impedance sensor and metered by the capacitance analyzer as a first change in capacitance,
wherein the capacitance analyzer calculates a change in water volume in the hydraulic circuit from the first change in capacitance, and
wherein the capacitance analyzer calculates a volume of waste added to the toilet bowl from the change in water volume.

3. The method of claim 1, wherein the electrodes comprise of two substantially parallel metal strips, the configuration of which is independently selected from the following: annular, semi-annular, and linear.

4. The method of claim 3, wherein the first noncontact electrical impedance sensor is oriented in one or more of the following configurations relative to the flow of water through the toilet hydraulic circuit: vertical, horizontal, and diagonal.

5. The method of claim 2, wherein processor records the volume of waste deposited into the toilet bowl during each use.

6. The method of claim 2, further comprising the step of providing a controller, wherein the controller signals refilling of the toilet bowl after a flush.

7. The method of claim 6, wherein the controller signals refilling of the toilet to a level that is less than the height of the spillway.

8. The method of claim 2, wherein toilet hydraulic circuit further comprises a gas sensor, wherein the gas sensor detects volatile organic compounds and is connected to the processor.

9. The method of claim 2, wherein the toilet hydraulic circuit further comprises a colorimeter and wherein the colorimeter is connected to the processor.

10. The method of claim 2, further comprising the step of providing a blood pressure monitor, wherein the blood pressure monitor is connected to the processor.

11. The method of claim 1, wherein the toilet hydraulic circuit further comprises a second noncontact electrical impedance sensor disposed adjacent to the electrical insulator and positioned on the curved pipe between overflow point and a sewer pipe.

12. The method of claim 11, further comprising the step of providing a processor, wherein the processor comprises a capacitance analyzer and is connected to the first and second noncontact electrical impedance sensors,
wherein a change in the height of water within the water seal is detected by the first noncontact electrical impedance sensor and metered by the capacitance analyzer as a first change in capacitance,
wherein the capacitance analyzer calculates a change in water volume in the hydraulic circuit from the first change in capacitance,
wherein the capacitance analyzer calculates a volume of waste added to the toilet bowl from the change in water volume,
wherein a change in the flow rate through the spillway is detected by the second noncontact electrical impedance sensor and metered by the capacitance analyzer as a second change in capacitance,
wherein the capacitance analyzer calculates a change in flow rate through the hydraulic circuit from the second change in capacitance, and
wherein the capacitance analyzer calculates a rate of excrement from the change in flow rate.

13. The method of claim 11, wherein the electrodes of the second noncontact electrical impedance sensor comprise of two substantially parallel metal strips, the configuration of which is independently selected from the following: annular, semi-annular, and linear.

14. The method of claim 11, wherein the second noncontact electrical impedance sensor is oriented in one or more of the following configurations relative to the flow of water through the toilet hydraulic circuit: vertical, horizontal, and diagonal.

15. The method of claim 12, wherein processor records the volume and flow rate of waste deposited into the toilet bowl during each use.

16. The method of claim 15, wherein the processor compares the volume and flow rate of waste deposited into the toilet bowl to a range of values defined as normal and wherein the processor generates a report identifying whether the volume and flow rate are within or without of the defined normal range.

17. The method of claim 12, further comprising the step of providing a controller, wherein the controller signals refilling of the toilet bowl after a flush.

18. The method of claim 17, wherein the controller signals refilling of the toilet to a level that is less than the height of the spillway.

19. The method of claim 12, wherein toilet hydraulic circuit further comprises a gas sensor, wherein the gas sensor detects volatile organic compounds, and is connected to the processor.

20. The method of claim 12, wherein the first and second noncontact electrical impedance sensors detect an abnormal volume and flow rate in the P-trap and wherein the processor is calibrated to report a potential clog.
